(19) United States
(12) Patent Application Publication
(10) Pub. No.: US 2026/0050114 A1
(43) Pub. Date: Feb. 19, 2026

(54) REFLECTIVE POLARIZING OPTICAL ELEMENT, OPTICAL DEVICE, DISPLAY APPARATUS, AND METHOD FOR MANUFACTURING REFLECTIVE POLARIZING OPTICAL ELEMENT

(71) Applicant: CANON KABUSHIKI KAISHA, Tokyo (JP)

(72) Inventors: KOUJIROU IZUMIDATE, Chiba (JP); KOUICHI YONETANI, Kanagawa (JP); KUMIKO YASHIMA, Tokyo (JP)

(21) Appl. No.: 19/288,133

(22) Filed: Aug. 1, 2025

(30) Foreign Application Priority Data
Aug. 13, 2024 (JP) 2024-134894

(51) Int. Cl. G02B 5/30; G02B 27/01

(52) U.S. Cl. CPC G02B 5/3058; G02B 27/0172

(57) ABSTRACT

A reflective polarizing optical element includes: a substrate including a curved surface portion having a surface forming a curved surface, the curved surface portion having, in a plan view in an optical axis direction, when the curved surface portion has a shape surrounded by a plurality of arcs each forming a part of the same circle in the plan view, and by a line connecting ends of adjacent arcs among the plurality of arcs, a short diameter that is defined by the shortest diameter among diameters passing through a center point of the circle; and a reflective polarizing film for a polarization beam splitter having a wire grid structure, which is to be adhered to the curved surface portion so that an angle formed between an extending direction of wires in the reflective polarizing film and an extending direction of the short diameter of the substrate falls within 45°.

### BACKGROUND

### Field of the Technology

The present disclosure relates to a reflective polarizing optical element, an optical device, a display apparatus, and a method for manufacturing a reflective polarizing optical element.

### Description of the Related Art

In recent years, a head mounted display has been used in various fields including virtual reality (VR), for example, in the fields of augmented reality (AR) and mixed reality (MR). The head mounted display includes an optical system for causing an image displayed on a display to be formed at a position of an eye of a user. In the head mounted display, an optical system that is reduced in size and weight and has a high image quality is achieved by folding an optical path through use of linear polarization, circular polarization, and a half mirror. Further, in the head mounted display, for a nose recess for the time of being worn by a user, a shape of each optical element is often not an axisymmetric circular shape unlike a digital camera, but a non-axisymmetric shape that is obtained by cutting off at least one side and has a long axis and a short axis.

In order to impart suitable polarization characteristics to such an optical element, a film having optical characteristics, such as a polarizing film, a polarization beam splitter (PBS) film, or a phase difference film, is laminated onto a substrate having a curved surface. The head mounted display is provided with the optical element obtained in this way, and thus can be reduced in size and weight.

Japanese Patent Laid-Open No. 2014-139664 discloses a reflective polarizing optical element in which a film having a wire grid structure (hereinafter referred to as “wire grid film”) is adhered as a polarization beam splitter film to a curved substrate having a shape like, for example, a spectacle lens. However, it is becoming recognized that, when a wire grid film is adhered to a curved substrate, appearance of the reflective polarizing optical element may be deteriorated due to generation of cracks in the wire grid structure and generation of haze in a base material.

### SUMMARY

The present disclosure has been made in view of such recognition, and is directed to reduce a risk of deterioration of appearance of a reflective polarizing optical element at the time when a wire grid film is adhered to a curved substrate.

In order to solve the problems described above, according to one aspect of the present disclosure, there is provided a reflective polarizing optical element including: a substrate including a curved surface portion having a surface forming a curved surface, the curved surface portion having, in a plan view as viewed in an optical axis direction, when the curved surface portion has a shape surrounded by a plurality of arcs, each of which forms a part of the same circle in the plan view, and by a line connecting ends of adjacent arcs among the plurality of arcs, a short diameter that is defined by the shortest diameter among diameters passing through a center point of the circle in the plan view, the curved surface portion having, when the curved surface portion has a shape formed of an outer shape including a plurality of arcs having different curvatures, a short diameter that is defined by the shortest diameter among diameters passing through a centroid point of the outer shape in the plan view; and a wire grid film for a polarization beam splitter having a wire grid structure, the wire grid film being configured to be adhered to the curved surface portion so that an angle formed between an extending direction of wires in the wire grid film and an extending direction of the short diameter of the substrate falls within 45°.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic top view for illustrating the structure of an example of a reflective polarizing optical element according to a first embodiment.

FIG. 1B is a schematic sectional view for illustrating the structure of the example of the reflective polarizing optical element according to the first embodiment.

FIG. 2A is a schematic top view for illustrating an example of a substrate shape of the reflective polarizing optical element according to the first embodiment.

FIG. 2B is a schematic top view for illustrating another example of the substrate shape of the reflective polarizing optical element according to the first embodiment.

FIG. 2C is a schematic top view for illustrating still another example of the substrate shape of the reflective polarizing optical element according to the first embodiment.

FIG. 3 is a schematic view for illustrating the sectional structure of an example of a polarization beam splitter film used in an embodiment.

FIG. 4A is a schematic view for illustrating the structure of an example of a manufacturing apparatus according to the first embodiment.

FIG. 4B is a top view for illustrating a positional relationship between a substrate arranged in a manufacturing apparatus and a wire grid film.

FIG. 5A is a view for illustrating an example of the wire grid film to be adhered and an accompanying configuration.

FIG. 5B is a view for illustrating another example of the wire grid film to be adhered and an accompanying configuration.

FIG. 5C is a view for illustrating still another example of the wire grid film to be adhered and an accompanying configuration.

FIG. 6A is an explanatory view of an example of a method for manufacturing a reflective polarizing optical element, for illustrating one step of the manufacturing method.

FIG. 6B is an explanatory view of the example of the method for manufacturing a reflective polarizing optical element, for illustrating one step of the manufacturing method.

FIG. 6C is an explanatory view of the example of the method for manufacturing a reflective polarizing optical element, for illustrating one step of the manufacturing method.

FIG. 6D is an explanatory view of the example of the method for manufacturing a reflective polarizing optical element, for illustrating one step of the manufacturing method.

FIG. 7 is a view for illustrating a positional relationship between the wire grid film and the substrate in Example 7.

FIG. 8 is a schematic view for illustrating an example of an optical device according to a second embodiment.

FIG. 9A is a schematic view for illustrating another example of the optical device (display apparatus) according to the second embodiment.

FIG. 9B is a schematic front view for illustrating the optical device exemplified in FIG. 9A.

FIG. 9C is a schematic view for illustrating an example of an optical configuration of the optical device exemplified in FIG. 9A.

### DESCRIPTION OF THE EMBODIMENTS

Now, exemplary embodiments and Examples are described in detail with reference to the drawings. In the following description, common components throughout the plurality of drawings are denoted by common reference symbols. Accordingly, common components are described with reference to the plurality of drawings mutually, and description of the components denoted by the common reference symbols is omitted as appropriate. Further, dimensions, materials, shapes, relative positions of the components, and the like illustrated in the following embodiments and Examples may be freely selected, and can be changed in accordance with various conditions or a configuration of an apparatus to which the present disclosure is applied.

### First Embodiment

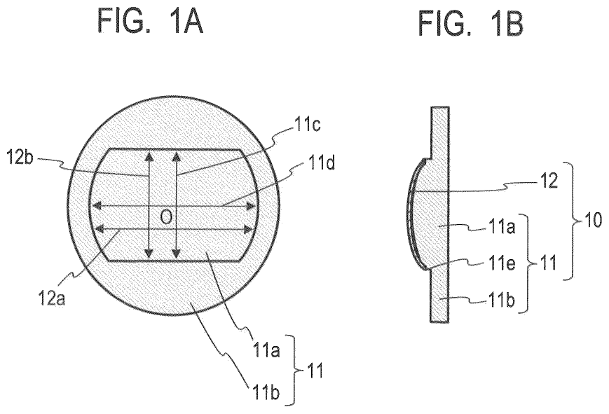

Now, a reflective polarizing optical element and a method for manufacturing a reflective polarizing optical element according to a first embodiment of the present disclosure are described with reference to FIG. 1A to FIG. 6D. FIG. 1A and FIG. 1B are schematic views for illustrating an example of a reflective polarizing optical element according to this embodiment. FIG. 1A is a plan view for illustrating a reflective polarizing optical element 10 as viewed from a light incident direction, and FIG. 1B is a sectional view of the reflective polarizing optical element 10 taken along an arraying direction 12a of wires to be described later.

As illustrated in FIG. 1A and FIG. 1B, the reflective polarizing optical element 10 according to this embodiment includes a substrate 11 and a wire grid film 12. The arraying direction 12a of the wires and an extending direction 12b of the wires in the wire grid film 12 are described later. The exemplified substrate 11 includes a curved surface portion 11a, a peripheral edge portion 11b, and a step portion lie. The curved surface portion 11a has a segmental circle shape obtained by removing portions of the circle outside two opposed sides in a plan view of a surface of the substrate 11 as viewed from a direction parallel to an optical axis of the reflective polarizing optical element 10. Here, the two opposed sides are straight lines, but may be curves. The peripheral edge portion 11b is formed adjacent to the curved surface portion 11a so as to surround the curved surface portion 11a in a plan view. The step portion 11e is arranged so as to connect the curved surface portion 11a and the peripheral edge portion 11b together, and is formed here so as to have a surface parallel to the optical axis direction.

In the substrate 11 exemplified in FIG. 1A and FIG. 1B, the curved surface portion 11a has a short diameter 11c and a long diameter 11d when viewed in a plan view. Here, the long diameter corresponds to a length of an axis with the longest distance passing through a center point O calculated from an arc portion of the curved surface portion 11a in a plan view, and the short diameter corresponds to a length of an axis with the shortest distance passing through the center point O calculated from the arc portion of the curved surface portion 11a. Accordingly, as in a case in which the curved surface portion 11a has a non-axisymmetric shape, in conformity to the shape and the like of the curved surface portion 11a in a plan view, the long diameter and the short diameter are not always required to be orthogonal to each other, and depending on the shape and the like, a plurality of short diameters and a plurality of long diameters can be selected. Further, the curved surface portion 11a is convex or concave, or may be aspherical.

The peripheral edge portion 11b is an optically non-effective region and is provided, for example, to serve as a mold release margin when the substrate 11 is manufactured, particularly when the substrate 11 is manufactured by injection molding. Further, the peripheral edge portion 11b may be provided in order to mount the completed reflective polarizing optical element 10 to a casing of an optical device such as a head mounted display. Accordingly, the peripheral edge portion 11b may have, regardless of curved surface or flat surface in particular, an axisymmetric shape or a non-axisymmetric shape. Further, the peripheral edge portion 11b is not required to be provided over the entire circumference of the curved surface portion 11a, and may be provided in a part of the circumference of the curved surface portion 11a. The peripheral edge portion 11b may also be omitted.

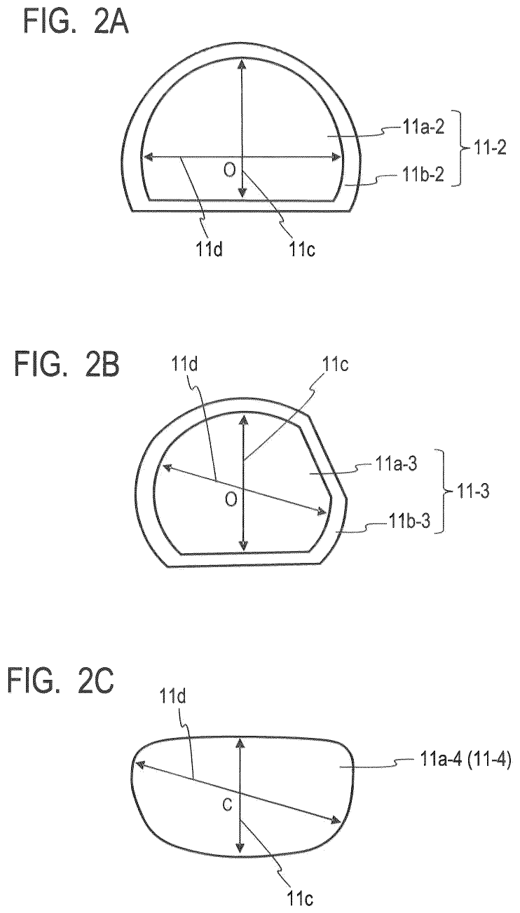

The shape of the substrate when viewed in a plan view, which is assumed in implementing the present disclosure, is not limited to the shape exemplified in FIG. 1A and FIG. 1B. Other examples of the shape of the substrate are described with reference to FIG. 2A to FIG. 2C. FIG. 2A to FIG. 2C are plan views for illustrating other examples of the shape of the substrate in a plan view as viewed in the optical axis direction of the substrate.

In the case of a substrate 11-2 exemplified in FIG. 2A, in a plan view, a curved surface portion 11a-2 has a segmental circle shape obtained by removing a portion of the circle outside a straight line. Further, a peripheral edge portion 11b-2 is arranged as a shape similar to the curved surface portion 11a-2 so as to surround an outer circumference of the curved surface portion 11a-2. In the example of the substrate 11-2, the short diameter 11c is a diameter defining the shortest distance, which passes through the center point O in a plan view, and the long diameter 11d is a diameter defining the longest distance, which passes through the center point O and is in the direction perpendicular to the short diameter 11c.

In the case of a substrate 11-3 exemplified in FIG. 2B, in a plan view, a curved surface portion 11a-3 has a shape obtained by connecting, by arcs, two sides that are not opposed to each other across the center, or a shape obtained by removing two regions in a circle outside straight lines that are not opposed to each other. The shape can also be defined as a segmental circle shape obtained by removing different portions of a circle outside two straight lines. The two unopposed sides or the two unopposed straight lines may be formed by curves. Further, the number of portions of the circle to be removed is not limited to two, and the shape may be obtained by removing a larger number of portions of the circle.

A peripheral edge portion 11b-3 is arranged as a shape similar to the curved surface portion 11a-3 so as to surround an outer circumference of the curved surface portion 11a-3. In the example of the substrate 11-3, the short diameter 11c is a diameter defining the shortest distance, which passes through the center point O in a plan view, and the long diameter 11d is a diameter, which passes through the center point O and defines the longest distance regardless of an extending direction of the short diameter 11c. The center point O matches a center point of a circle forming a part of an outer shape of the curved surface portion 11a-3 in a plan view. In the curved surface portion 11a-3, the short diameter 11c and the long diameter 11d are not orthogonal to each other.

In the example of FIG. 1A, FIG. 2A, or FIG. 2B, a case in which the curved surface portion includes two straight lines or one straight line in a plan view is described. However, the number of straight lines forming the curved surface portion is not limited to two, and a plurality of three or more straight lines may be included in a plan view of the substrate. In this case, the curved surface portion is only required to include, in a plan view, a plurality of three or more arcs which are parts of the circumference of the same circle, and two adjacent ends of the plurality of straight lines are only required to be connected by each of the arcs.

In the case of a substrate 11-4 exemplified in FIG. 2C, in a plan view, a curved surface portion 11a-4 has a shape formed of a plurality of arcs having different curvatures like, for example, a spectacle lens. As exemplified here, the substrate 11-4 can be formed so as not to include the peripheral edge portion unlike FIG. 1A to FIG. 2B.

Further, in the exemplified substrate 11-4, there is no same circle, and hence the center point cannot be determined in a plan view of the substrate 11-4. In such a case, a centroid point C of the curved surface portion 11a-4 in a plan view of the substrate 11-4 can be used as the reference point. With the centroid point C of the shape of the curved surface portion 11a-4 in a plan view being used as the reference point, the short diameter 11c is defined as the shortest diameter among diameters passing through the centroid point C, and the long diameter 11d is defined as the longest diameter among the diameters passing through the centroid point C.

An optical device, in particular, a head mounted display in which the reflective polarizing optical element 10 is used is assumed to be worn on a face, in particular, on a part of eyes and a nose of the user, and hence there are restrictions in size of the device. Accordingly, for the purposes of providing a nose recess for the user and securing an installing space for electronic devices such as a motor and a sensor, the shape of the substrate is often not an axisymmetric shape, but a non-axisymmetric shape including a short diameter and a long diameter. In such a case, the substrate shape exemplified in FIG. 2C is assumed. For such a substrate and a curved surface portion, the short diameter and the long diameter can be defined through use of the centroid point C as the reference point as described above.

Here, a curvature of the curved surface portion 11a of the substrate 11 exemplified in FIG. 1A and FIG. 1B is defined as R (the optimum value by least squares in the case of aspherical surfaces). Further, when L2 represents a length of the long diameter 11d of the curved surface portion 11a, L1 represents a length of the short diameter 11c, and θ represents a half field angle, the following formula is satisfied.

sin θ=(L2/2)/R

Any material regardless of plastic or glass can be used as the material for the substrate described above as long as the material is a transparent material that has transparency to light such as visible light being a target of the reflective polarizing optical element 10. When plastic is used, a material that can be formed by injection molding and that is optically used is preferably used. Examples of the material to be used include polycarbonate (PC), polyester (PEs), polymethyl methacrylate (PMMA), a cycloolefin polymer (COP), and a cycloolefin copolymer (COC). In addition, when glass is used, a material thereof is not particularly limited, and examples thereof include synthetic quartz and BK-7 serving as a general glass material.

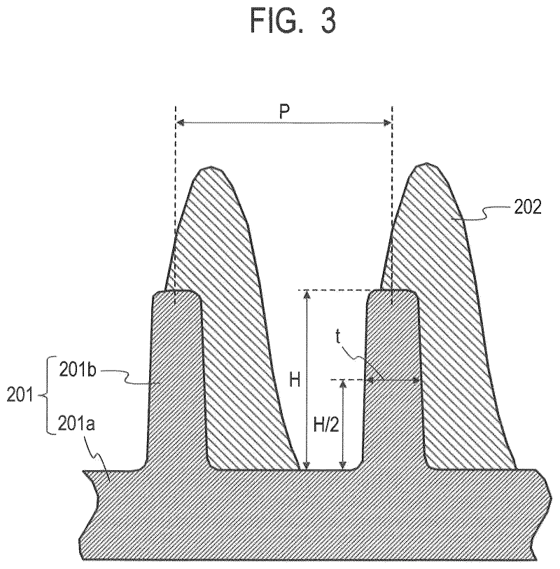

Next, details of a wire grid film used as a polarization beam splitter film in this embodiment are described with reference to FIG. 3. FIG. 3 schematically shows the sectional structure of the wire grid film when taken along the arraying direction of the wires.

The wire grid film 12 includes a base resin film 201 and metal layers 202. The base resin film 201 has such an uneven shape on its surface that, on a sheet 201a made of, for example, a triacetyl cellulose (TAC) resin, fine projecting portions 201b made of, for example, the same resin are formed. The sheet 201a and the projecting portions 201b can also be made of different materials. The projecting portions 201b are formed at intervals of a pitch P so as to have a height H and a width “t”, and extend in a direction perpendicular to the plane of the drawing sheet. The metal layers 202 are wires that are made of conductive metal and deposited on the fine uneven shape of the base resin film 201. The metal layers 202 are made of conductive metal typified by, for example, aluminum, and are provided so as to be periodically arrayed in a certain direction along an extending direction of the projecting portions 201b. The wire grid film 12 has such optical characteristics as to transmit light with polarization parallel to the arraying direction 12a of the wires, and reflect light with polarization parallel to the extending direction 12b of the wires due to electromagnetic interaction between incident light and the wires forming the fine uneven shape (see FIG. 1A and FIG. 1B).

As described above, as one of factors determining performance of the wire grid film 12, there can be given a relationship between the pitch P of the projecting portions 201b in the base resin film 201 and a wavelength λ of the incident light. In a range in which the pitch P is from about one-half to about twice the wavelength, polarization separation performance is significantly degraded for light of a specific wavelength. Further, as the pitch P becomes smaller, processing becomes more difficult while good polarization characteristics are exhibited over a wide wavelength range. Accordingly, in this embodiment, the pitch P is set to 120 nm from the following two viewpoints: keeping the incident light smaller than one-half of a wavelength of 380 nm, which is the short wavelength of visible light; and facilitating shape processing.

In the wire grid film 12 used in this embodiment, the metal layers 202 are formed using the oblique vapor deposition method. According to the oblique vapor deposition method, depending on a vapor deposition shadowing effect exerted by the projecting portions 201b of the base resin film 201, a growth direction of the metal layer 202 may be oblique in a sectional view and may be coupled to another adjacent metal layer. Such coupling between metal layers during formation of the metal layers 202 causes a decrease in parallel transmittance. In particular, in a case in which the height H of the projecting portion 201b is smaller than 120 nm when the pitch P is set to 120 nm, an appropriate vapor deposition shadowing effect cannot be obtained, resulting in that the metal layers may be easily coupled to each other during formation of the metal layers 202. Accordingly, it is important to control the vapor deposition shadowing effect of the projecting portions 201b. Meanwhile, when the height H of the projecting portion 201b exceeds 120 nm, the vapor deposition shadowing effect of the projecting portions 201b becomes excessive, and hence the growth of the metal layer in a recessed portion is insufficient. Thus, a contact area between the metal layer and a bottom surface of the recessed portion in the recessed portion is small, and hence rigidity for maintaining the wire grid structure is insufficient. As a result, durability of polarization separation performance is reduced. From the above-mentioned two viewpoints of reducing a risk of coupling between the metal layers and maintaining a configuration of the wire grid structure, in this embodiment, the height H of the projecting portion 201b of the base resin film 201 in the wire grid film 12 is set to 120 nm.

Next, the width “t” of the projecting portion at a position of H/2 of the projecting portion 201b was studied. The width of the projecting portion at the position of H/2 was set smaller than 32 nm under a projecting portion pitch of 120 nm and a projecting portion height of 120 nm, and oblique vapor deposition was performed. In this case, coupling between metal layers occurred during formation of the metal layers 202, resulting in a decrease in parallel transmittance. Meanwhile, when the width “t” of the projecting portion at the position of H/2 of the projecting portion 201b exceeds 32 nm, a spacing between adjacent projecting portions is narrow, which hinders vapor deposition. Thus, the contact area between the metal layer and the bottom surface of the recessed portion in the recessed portion was small, and hence rigidity for maintaining the wire grid structure was insufficient, resulting in a reduction in durability of the polarization separation performance. From the above-mentioned two viewpoints of reducing a risk of coupling between metal layers and maintaining the configuration of the wire grid structure, in this embodiment, the width “t” of the projecting portion at the position of H/2 of the projecting portion 201b of the base resin film 201 in the wire grid film 12 is set to 32 nm.

For the reasons described above, in this embodiment, the base resin film 201 is used, in which the pitch P between the projecting portions 201b is 120 nm, the height H of the projecting portion 201b is 120 nm, and the width of the projecting portion at the position of H/2 of the projecting portion 201b is 32 nm. This can provide a moderate vapor deposition shadowing effect exerted by the projecting portions 201b during formation of the metal layers 202 using the oblique vapor deposition method, and allows the metal layers 202 to grow vertically. Thus, the metal layers 202 each have a vertically elongated shape in a sectional view, thereby being capable of preventing a decrease in transmittance due to coupling between adjacent metal layers.

Here, the wire grid film, which is a subject of this embodiment, includes the base resin film 201, and wires that are coated with a part of the film and formed of the metal layers 202 as illustrated in FIG. 3. At the time when the wire grid film 12 is adhered to the substrate 11, the film is often subjected to a force of pulling the film toward its outer circumference, which causes stretching of the film. At this time, when the stretching occurs in the extending direction 12b of the wires, it is considered that stretching of the base resin film 201 proceeds preferentially over stretching of the metal layers 202 in deformation of the film. This deformation of the base resin film 201 results in a state in which a thickness at the position of H/2 of the projecting portion 201b illustrated in FIG. 3 gradually decreases along with an increase in stretching in the extending direction 12b of the wires. Along with the decrease in thickness, rigidity for supporting the metal layers 202 on the projecting portions 201b decreases, which may cause tilting of wires. This tilting of wires leads to narrowing of the pitch between adjacent wires. Further, when tilting of the wires is excessive, scattering of incident light onto a sidewall of the tilted wire causes deterioration of appearance of the element. It is considered that the problems to be solved in the present invention may arise from those mechanisms as one factor.

The details of the present invention to be described below with regard to embodiments and the like are based on the above-mentioned findings, and are directed to reduce stretching of the wire grid film 12 in the extending direction of the wires. With this reduction in stretching being achieved, a risk of degradation of polarization transmission characteristics and a risk of deterioration of appearance are reduced. Specifically, the extending direction of the short diameter 11c and the extending direction 12b of the wires are arranged in a state of being substantially parallel to each other. However, depending on the shape of the substrate, it may not be easy to clearly define the short diameter 11c, resulting in that there may be cases in which the extending direction of the short diameter 11c and a direction in which the wire grid film 12 is most stretched cannot be matched with each other at the time when the wire grid film 12 is adhered to the curved surface portion 11a. Even in such a case, when p represents an angle formed between the extending direction of the short diameter 11c and the extending direction 12b of the wires, with φ≤45° being satisfied, a region in which an amount of stretching of the wire grid film is relatively small can be substantially matched with the extending direction 12b. Further, when the angle is larger than 45°, there is a higher risk in that the curved surface portion 11a includes a region with a large amount of stretching in which deterioration of appearance of the wires begins to occur. With the setting of such conditions, it is possible to reduce a risk of deterioration of appearance in the reflective polarizing optical element, in particular, deterioration at the outer circumferential portion of the element.

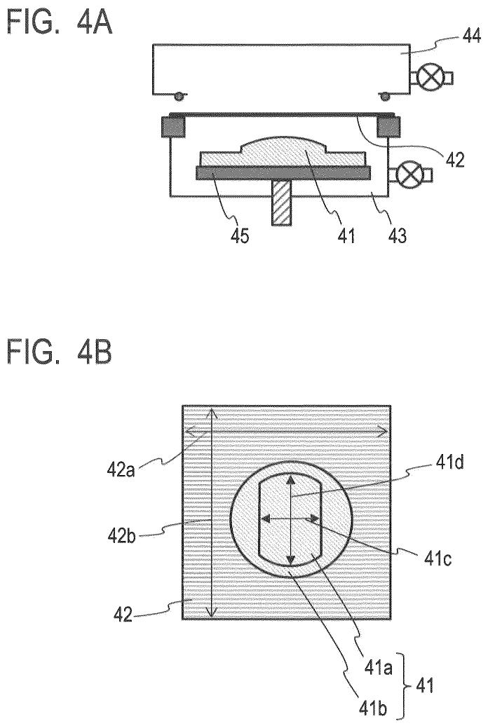

Next, with reference to FIG. 4A and FIG. 4B, a manufacturing apparatus for the reflective polarizing optical element 10 according to this embodiment is described. FIG. 4A is a sectional view for illustrating schematic configurations of the manufacturing apparatus, and a substrate 41 and other components held inside the manufacturing apparatus. Further, FIG. 4B is a top view for illustrating a positional relationship between the substrate 41 arranged in the manufacturing apparatus and a wire grid film 42 placed on top of the substrate when seen through from above.

As illustrated in FIG. 4A and the like, the manufacturing device used in this embodiment includes a first chamber 43, a second chamber 44, and a stage 45. The first chamber 43 and the second chamber 44 can each independently exhaust the inside thereof to reduce the pressure. In an upper portion of the first chamber 43 and a corresponding lower portion of the second chamber 44, opening portions which can be connected to each other are provided. An example in which those chambers are arranged in the vertical direction is given here, but this arrangement is exemplary. The chambers can be arranged laterally or in an arrangement turned upside down.

Inside the first chamber 43, the stage 45 is arranged so as to be capable of moving, for example, ascending and descending, relative to the second chamber 44, while supporting the substrate 41. Similarly to the substrate 11 exemplified in FIG. 1A and FIG. 1B, the substrate 41, which includes a curved surface portion 41a and a peripheral edge portion 41b and whose short diameter 41c and long diameter 61d are defined on the curved surface portion 41a, is placed on the stage 45 (see FIG. 4B). Further, the wire grid film 42 is arranged between the first chamber 43 and the second chamber 44, which are connected to each other via the above-mentioned opening portions.

At this time, as illustrated in FIG. 4B, in a plan view, the substrate 41 including the curved surface portion 41a and the peripheral edge portion 41b is arranged to face the wire grid film 42 so that an extending direction 42a of the wires and an extending direction of the short diameter 41c of the substrate 41 match each other. When the substrate 41 and the wire grid film 42 are laminated onto each other in such a positional relationship, at the time of adhering, a length of the curved surface portion 41a in the extending direction 42a of the wires of the wire grid film 42 is short. As a result, a portion of the wire grid film 42 with a large amount of stretching, in which the wires may be significantly tilted, can be located on an outside of the curved surface portion 41a of the substrate 41. Thus, it is possible to reduce a risk of deterioration of appearance due to tilted wires of the wire grid film 42 in the curved surface portion 41a.

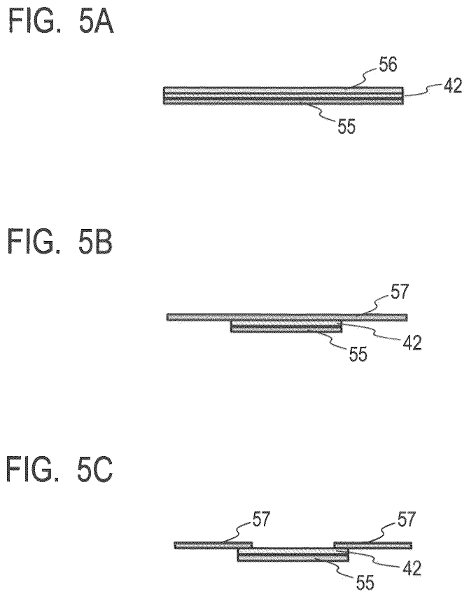

In the manufacture of the reflective polarizing optical element 10, the wire grid film 42 can be accompanied with other configurations. Those configurations are described with reference to FIG. 5A to FIG. 5C. FIG. 5A to FIG. 5C each schematically show a cross-section of the wire grid film and the like to be used in an adhering step.

As exemplified in FIG. 5A, a uniform adhesive layer 55 can be provided on a surface of the wire grid film 42 on the substrate side. Further, a protective film 56 that is used for protecting a surface of the wire grid film 42 can also be provided on a surface (surface opposite to the adhesive layer 55) of the wire grid film 42 on a side opposite to the substrate side. It is required that a glass transition temperature of the protective film 56 be lower than a glass transition temperature of the wire grid film 42. This increases the strength of the wire grid film 42, and hence the wire grid film 42 is less liable to tear or break when the wire grid film 42 is adhered to the substrate 41.

Further, the wire grid film 42 is expensive as compared to a general film. Accordingly, from the viewpoint of reducing the manufacturing cost, it is inappropriate to use a wire grid film 42 having a size excessively larger than the area of the curved surface portion 41a of the substrate 41. That is, the wire grid film 42 is only required to have a size slightly larger than a surface area of the curved surface portion 41a of the substrate 41. Specifically, for example, the wire grid film 42 is only required to have an area that is from 1.5 times to 2.5 times the area of the curved surface portion 41a in a plan view as viewed in the optical axis direction of the substrate 41.

Here, when the size of the wire grid film 42 is reduced as much as possible, at the time of holding the wire grid film 42 between the first chamber 43 and the second chamber 44, it is required to, for example, secure also the size required for this holding. Accordingly, as illustrated in FIG. 5B, on the wire grid film 42, a support film 57 formed of a member separate from the wire grid film 42 may be adhered. At this time, in order to obtain a uniform film warpage at the time of heating the film, it is preferred that the glass transition temperature of the support film 57 be a temperature equivalent to or lower by about 20° C. than the glass transition temperature of the wire grid film 42.

Further, as illustrated in FIG. 5C, a support film 57 may be adhered only to the outer peripheral portion of the wire grid film 42. The support film 57 can be separated from the wire grid film 42 at an appropriate timing after the wire grid film 42 is adhered to the substrate 41.

In a step of adhering the wire grid film 42, the wire grid film 42 and the like described above are held between the first chamber 43 and the second chamber 44. In the manufacturing apparatus described in this embodiment, the stage 45 is provided so that a tangent line at the center point of the short diameter 41c of the substrate 41 is parallel to the wire grid film 42. With this configuration, in the substrate 41, a situation of stretching of the wire grid film 42 along the extending direction of the short diameter 41c is symmetrical about the center point of the short diameter 41c. This prevents the wire grid film 42 from having a region with partially large stretching due to the adhering, and the wire grid film 42 can be adhered with the maximum stretching rate of the wire grid film 42 being reduced. As a result, it is possible to further reduce a risk in that the wire grid film 42 with tilted wires exists on the curved surface portion 41a of the substrate 41, and to suppress the deterioration of appearance due to tilting of the wires.

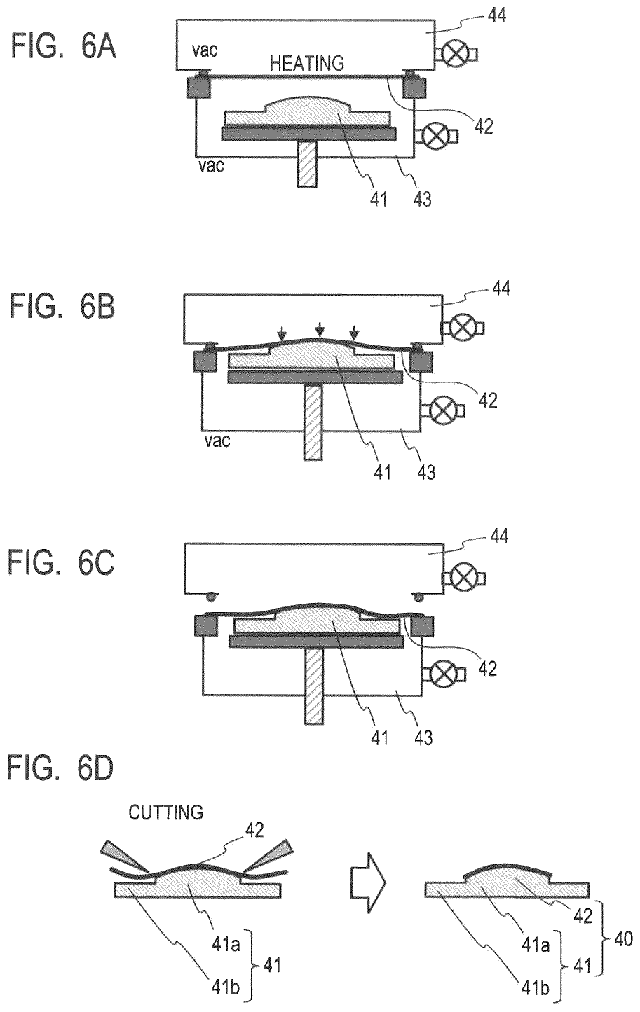

Next, the step of adhering the wire grid film 42 to the substrate 41 through use of the manufacturing apparatus described with reference to FIG. 4A is described with reference to FIG. 6A to FIG. 6D. After the substrate 41 and the wire grid film 42 are arranged in the manufacturing apparatus as illustrated in FIG. 4A, a vacuum is created in the first chamber 43 and the second chamber 44 as illustrated in FIG. 6A. Then, the wire grid film 42 is heated through use of, for example, a heater installed in the second chamber 44. After heating the wire grid film 42 to a desired temperature, as illustrated in FIG. 6B, the stage 45 (see FIG. 4A) is raised to bring the curved surface portion 41a of the substrate 41 into contact with the wire grid film 42. The stage 45 is further raised so that the wire grid film 42 is adhered to an entire surface of the curved surface portion 41a.

Then, the wire grid film 42 is pressurized and pressed onto the substrate 41 by opening only the second chamber 44 to the atmosphere to increase the pressure, and as required, by adding high-pressure gas. At this time, as required, heating and pressurizing of the wire grid film 42 may be continued for a certain period of time.

Here, as measures for heating the wire grid film 42, an infrared heater that directly heats the film is generally used, but there is also a method in which the entire first chamber 43 and second chamber 44 are heated by a heater or the like. In this case, the substrate 41 is also heated. In particular, when the substrate 41 is made of a plastic material, there is a fear of deformation due to heat. Accordingly, it is important that the stage 45 that supports the substrate 41 or a pedestal that is used for tilting and supporting the substrate 41 has the heat insulating structure. In other words, it is preferred that, regardless of the temperature of the wire grid film 42, the temperature of the substrate 41 be 120° C. or less.

After that, as illustrated in FIG. 6C, the heating and pressurizing of the polarization beam splitter film 42 is stopped, the second chamber 44 is restored to atmospheric pressure, and then the first chamber 43 is also opened to the atmosphere. Subsequently, the substrate 41 to which the wire grid film 42 has been adhered is taken out. Next, as illustrated in FIG. 6D, unrequired portions of the wire grid film 42 are cut off so that the wire grid film 42 remains only on the curved surface portion 41a of the substrate 41. Examples of measures for cutting off the unrequired portions of the wire grid film 42 include a method of cutting off the unrequired portions of the wire grid film 42 by putting a blade along the outer edge of the curved surface portion 41a or by applying laser light along the outer edge of the curved surface portion 41a. In this way, a reflective polarizing optical element 40 is manufactured with the wire grid film 42 adhered to the curved surface portion 41a of the substrate 41.

Now, Examples in each of which the reflective polarizing optical element according to this embodiment was actually manufactured are described below. In the evaluation of the reflective polarizing optical element to be described below, a chord arc ratio in the extending direction of the wires is also determined. Herein, the chord arc ratio is expressed as a ratio of the shortest distance connecting two specific points on a curved surface of the reflective polarizing optical element on the curved surface to a distance connecting the two points by a straight line. That is, the chord arc ratio is calculated by the following formula.

Chord arc ratio (%)=(shortest distance between two specific end points on a curved surface of a curved surface portion of a substrate)/(distance connecting the two specific points by a straight line)×100

When the chord arc ratio is large, it is assumed that an amount of stretching of the wire grid film is large. Here, through use of a 3D scanner-type three-dimensional measuring device (VL-5000, manufactured by Keyence Corporation), shape data relating to the reflective polarizing optical element is obtained, and the chord arc ratio is calculated based on sectional shape data in a direction orthogonal or parallel to an extending direction of the fine uneven structure. The data for measurement of a wire pitch and measurement of a wire width was obtained using an electron microscope (JSM-F100, manufactured by JEOL Ltd.).

Specifically, the reflective polarizing optical element according to each of Examples to be described below was visually evaluated with regard to a wire width ratio, a wire pitch ratio, so-called “streak irregularity” in transmitted light, and tilting of wires. The wire width ratio was calculated from a ratio of the width of the metal layer at a center portion of the element to the width of the metal layer at an end portion of the element. The wire pitch ratio was also calculated from a ratio of a spacing between the metal layers at the center portion of the element to a spacing between the metal layers at the end portion of the element. Further, with regard to streak irregularity, a light table was used to illuminate the reflective polarizing optical element, and the presence or absence and a state of the streak irregularity in the transmitted light were checked. Then, based on the evaluation described above, a state of the wire grid in the reflective polarizing optical element was evaluated by classifying into A (best), B (good), C (acceptable), and D (defective).

### Example 1

In Example 1, as the substrate 41, a substrate which was molded by injection molding and made of plastic containing cyclic olefin copolymer (COC) as a main component was used. Further, the substrate 41 had the shape exemplified in FIG. 4A and FIG. 4B, and was a convex lens in which a length L1 of the short diameter 41c in the curved surface portion 41a was 28 mm, a length L2 of the long diameter 41d was 50 mm, and a half field angle θ was 10°. Further, for the wire grid film 42, the wire grid film 42 that had a thickness of about 100 m and was accompanied with the adhesive layer 55 was used, and a size was set to 160 mm×160 mm. Further, during manufacture, the substrate 41 and the wire grid film 42 were arranged so that the extending direction of the short diameter 41c of the curved surface portion 41a of the substrate 41 and the extending direction 42a of the wires of the wire grid film 42 were substantially parallel to each other (within ±2°).

During manufacture, an infrared heater was used to heat the wire grid film and the like, and an adhering step was performed after performing heating to a desired temperature (100° C.). After adhering, only the second chamber 44 was opened to the atmosphere, and compressed air was caused to flow into the second chamber 44 to increase the pressure to 0.3 MPa, thereby performing operation of pressurizing the wire grid film 42 and pressing the wire grid film 42 onto the substrate 41 for 10 seconds.

In the reflective polarizing optical element according to Example 1, it was confirmed that the wire width ratio or the wire pitch ratio was larger than 0.9. Further, it was confirmed that the chord arc ratio was smaller than 110% and close to 100%. Further, from visual observation, it was confirmed that tilting of the wires was slight in the reflective polarizing optical element. The state of streak irregularity in the transmitted light using a light table was also evaluated. As a result of the evaluation described above, the appearance of the reflective polarizing optical element according to Example 1 was able to be evaluated as the best as shown in Tables 1-1 and 1-2.

### Example 2

In Example 2, the shape (dimensions and the like) of the substrate 41 used in Example 1 was changed. Specifically, for the substrate 41, the length L1 of the short diameter 41c of the curved surface portion 41a was set to 38 mm, the length L2 of the long diameter 41d was set to 50 mm, and the half field angle θ was set to 50°. Except for the dimensions and the like, a reflective polarizing optical element was manufactured in the same way as in Example 1. Then, the appearance of this reflective polarizing optical element was evaluated based on the method and criteria described above. As a result, it was confirmed that the wire width ratio or the wire pitch ratio was larger than 0.9. Further, the chord arc ratio was slightly smaller than 110%. In addition, from visual observation, it was confirmed that tilting of the wires was increased in this reflective polarizing optical element as compared to Example 1. Then, the state of streak irregularity in the transmitted light using a light table was also evaluated. As a result of the evaluation described above, the appearance of the reflective polarizing optical element according to Example 2 was able to be judged as good as shown in Tables 1-1 and 1-2.

### Example 3

In Example 3, the shape (dimensions and the like) of the substrate 41 used in Example 1 was changed. Specifically, for the substrate 41, the length L1 of the short diameter 41c of the curved surface portion 41a was set to 38 mm, the length L2 of the long diameter 41d was set to 40 mm, and the half field angle θ was set to 48°. Except for the dimensions and the like, a reflective polarizing optical element was manufactured in the same way as in Example 1. Then, the appearance of this reflective polarizing optical element was evaluated based on the method and criteria described above. As a result, it was confirmed that the wire width ratio or the wire pitch ratio was larger than 0.9. Further, the chord arc ratio was slightly larger than 110%. In addition, from visual observation, it was confirmed that tilting of the wires was increased in this reflective polarizing optical element as compared to Example 2. Then, the state of streak irregularity in the transmitted light using a light table was also evaluated. As a result of the evaluation described above, the appearance of the reflective polarizing optical element according to Example 3 was able to be judged as acceptable as shown in Tables 1-1 and 1-2.

### Example 4

In Example 4, the shape (dimensions and the like) of the substrate 41 used in Example 1 was changed. Specifically, for the substrate 41, the half field angle θ of the curved surface portion 41a was set to 20°, and the substrate 41 was formed into a concave lens. Except for the dimensions and the like, a reflective polarizing optical element was manufactured in the same way as in Example 1. Then, the appearance of this reflective polarizing optical element was evaluated based on the method and criteria described above. As a result, it was confirmed that the wire width ratio or the wire pitch ratio was larger than 0.9. Further, it was confirmed that the chord arc ratio was smaller than 110% and close to 100%. In addition, from visual observation, it was confirmed that tilting of the wires was slight in this reflective polarizing optical element. Then, the state of streak irregularity in the transmitted light using a light table was also evaluated. As a result of the evaluation described above, the appearance of the reflective polarizing optical element according to Example 4 was able to be judged as the best as shown in Tables 1-1 and 1-2.

### Example 5

In Example 5, the shape of the substrate 41 used in Example 1 was changed to the shape exemplified in FIG. 2B. Specifically, for the substrate 11-2, the length L1 of the short diameter 11c-2 of the curved surface portion 11a-2 was set to 28 mm, the length L2 of the long diameter 11d-2 was set to 50 mm, and the half field angle θ was set to 17°. The substrate 11-2 was formed into a convex lens. Except for the dimensions and the like, a reflective polarizing optical element was manufactured in the same way as in Example 1. The appearance of this reflective polarizing optical element was evaluated based on the method and criteria described above. As a result, it was confirmed that the wire width ratio or the wire pitch ratio was larger than 0.9. Further, it was confirmed that the chord arc ratio was smaller than 110% and close to 100%. In addition, from visual observation, it was confirmed that tilting of the wires was slight. Then, the state of streak irregularity in the transmitted light using a light table was evaluated. As a result of the evaluation described above, the appearance of the reflective polarizing optical element according to Example 5 was judged as the best as shown in Tables 1-1 and 1-2.

### Example 6

In Example 6, the shape of the substrate 41 used in Example 1 was changed to the shape exemplified in FIG. 2B. Specifically, for the substrate 11-2, the length L1 of the short diameter 11c-2 of the curved surface portion 11a-2 was set to 38 mm, the length L2 of the long diameter 11d-2 was set to 40 mm, and the half field angle θ was set to 26°. The substrate 11-2 was shaped to include the flat peripheral edge portion 11b-2 with a width of 2 mm. Except for the dimensions and the like, a reflective polarizing optical element was manufactured in the same way as in Example 1. The appearance of this reflective polarizing optical element was evaluated based on the method and criteria described above. As a result, it was confirmed that the wire width ratio or the wire pitch ratio was larger than 0.9. Further, it was confirmed that the chord arc ratio was slightly smaller than 110%. Then, the state of streak irregularity in the transmitted light using a light table was evaluated. As a result of the evaluation described above, the appearance of the reflective polarizing optical element according to Example 6 was able to be judged as good as shown in Tables 1-1 and 1-2.

### Example 7

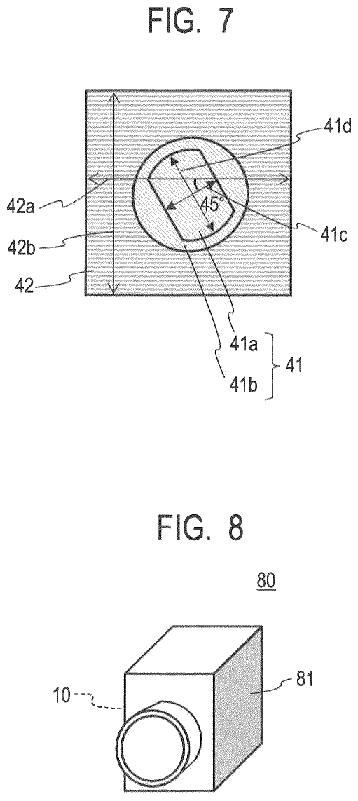

In Example 7, the shape (dimensions and the like) of the substrate 41 used in Example 1 was changed. Specifically, the half field angle θ was set to 20°, and the substrate 41 was shaped to include the flat peripheral edge portion 41b of φ56 mm. Further, during manufacture, the substrate 41 was arranged in the first chamber 43 so as to have the positional relationship as exemplified in FIG. 7. Specifically, the substrate 41 was arranged so that an angle formed between the extending direction of the short diameter 41c of the curved surface portion 41a of the substrate 41 and the extending direction 42a of the wires of the wire grid film 42 was 45°. A reflective polarizing optical element was manufactured in the same way as in Example 1, except for the width of the peripheral edge portion and the positional relationship between the wire grid film and the substrate during manufacture. The appearance of this reflective polarizing optical element was evaluated based on the method and criteria described above. As a result, it was confirmed that the wire width ratio or the wire pitch ratio was larger than 0.9. Further, it was confirmed that the chord arc ratio was slightly smaller than 110%. Then, the state of streak irregularity in the transmitted light using a light table was evaluated. As a result of the evaluation described above, the appearance of the reflective polarizing optical element according to Example 7 was able to be judged as good as shown in Tables 1-1 and 1-2.

### Example 8

In Example 8, the same substrate and the same wire grid film as those in Example 7 were used, and during manufacture, the substrate and the wire grid film were arranged so that the angle formed between the extending direction of the short diameter 41c of the curved surface portion 41a and the extending direction 42a of the wires of the wire grid film 42 was 30°. Except for this arrangement, a reflective polarizing optical element was manufactured in the same way as in Example 7. The appearance of this reflective polarizing optical element was evaluated based on the method and criteria described above. As a result, it was confirmed that the wire width ratio or the wire pitch ratio was larger than 0.9. Further, it was confirmed that the chord arc ratio was smaller than 110% and close to 100%. In addition, from visual observation, it was confirmed that tilting of the wires was slight. Then, the state of streak irregularity in the transmitted light using a light table was evaluated. As a result of the evaluation described above, the appearance of the reflective polarizing optical element according to Example 8 was able to be judged as the best as shown in Tables 1-1 and 1-2.

### Example 9

In Example 9, the shape of the substrate 41 in Example 1 was changed to the shape exemplified in FIG. 2C. In the case of the shape exemplified in FIG. 2C, unlike the case of the substrate described above, the center point O cannot be determined. For this reason, a centroid point C of the outer shape of the curved surface portion 11a-3 in a plan view is defined as a reference point, the shortest diameter passing through the reference point is defined as the short diameter 11c-3, and the longest diameter passing through the reference point is defined as the long diameter 11d-3. Further, in this example, the substrate 11-3 does not include a peripheral edge portion. As specific dimensions, the length L1 of the short diameter 11c of the curved surface portion 11a was set to 38 mm, the length L2 of the long diameter 11d was set to 40 mm, and the half field angle θ was set to 26°. Except for the dimensions and the like, a reflective polarizing optical element was manufactured in the same way as in Example 1. The appearance of this reflective polarizing optical element was evaluated based on the method and criteria described above. As a result, it was confirmed that the wire width ratio or the wire pitch ratio was larger than 0.9. Further, it was confirmed that the chord arc ratio was slightly smaller than 110%. Then, the state of streak irregularity in the transmitted light using a light table was evaluated. As a result of the evaluation described above, the appearance of the reflective polarizing optical element according to Example 9 was able to be judged as good as shown in Tables 1-1 and 1-2.

### Comparative Example 1

In Comparative Example 1, the shape of the substrate 41 used in Example 1 was changed so that the curved surface portion had a circular shape in a plan view. In this case, the length L1 of the short diameter of the curved surface portion of the substrate was set to 40 mm, the length L2 of the long diameter was set to 40 mm, and the half field angle θ was set to 48°. Except for the dimensions and the like, a reflective polarizing optical element was manufactured in the same way as in Example 1. The appearance of this reflective polarizing optical element was evaluated based on the method and criteria described above. As a result, it was confirmed that the wire width ratio or the wire pitch ratio was smaller than 0.9. Further, the chord arc ratio was larger than 110% and higher than that of the reflective polarizing optical element according to Example 3. In addition, from visual observation, it was confirmed that tilting of the wires was excessive. Then, the state of streak irregularity in the transmitted light using a light table was evaluated. As a result of the evaluation described above, the appearance of the reflective polarizing optical element according to Comparative Example 1 was able to be judged as defective as shown in Tables 1-1 and 1-2.

### Comparative Example 2

In Comparative Example 2, the shape (dimensions and the like) of the substrate 41 used in Example 1 was changed. Specifically, for the substrate 41, the length L1 of the short diameter 41c of the curved surface portion 41a was set to 38 mm, the length L2 of the long diameter 41d was set to 50 mm, and the half field angle θ was set to 50°. The substrate 41 was shaped to include a flat peripheral edge portion 41b of φ56 mm. Further, during manufacture, the substrate 41 and the wire grid film 42 were arranged so that the angle formed between the extending direction of the short diameter 41c of the curved surface portion 41a of the substrate 41 and the extending direction 42a of the wires of the wire grid film 42 was 50°. Except for the foregoing, a reflective polarizing optical element was manufactured in the same way as in Example 1. The appearance of this reflective polarizing optical element was evaluated based on the method and criteria described above. As a result, it was confirmed that the wire width ratio or the wire pitch ratio was smaller than 0.9. Further, the chord arc ratio was larger than 110% and higher than that of the reflective polarizing optical element according to Example 3. In addition, from visual observation, it was confirmed that tilting of the wires was excessive. Then, the state of streak irregularity in the transmitted light using a light table was evaluated. As a result of the evaluation described above, the appearance of the reflective polarizing optical element according to Comparative Example 2 was able to be judged as defective as shown in Tables 1-1 and 1-2.

TABLE 1-1

| | | | | Angle φ formed | |
|---|---|---|---|---|---|
| | | | | between extending | |
| | | | | direction of wires | |
| | | | Half | and extending | Short |
| | | | field | direction of short | diam- |
| | | Curved | angle | diameter of | eter |
| | Substrate | surface | θ | substrate | L1 |
| | shape | shape | [°] | [°] | [mm] |
| Example 1 | Shape 1 | Convex | 10 | 0 | 28 |
| Example 2 | Shape 1 | Convex | 50 | 0 | 38 |
| Example 3 | Shape 1 | Convex | 48 | 0 | 38 |
| Example 4 | Shape 1 | Concave | 20 | 0 | 28 |
| Example 5 | Shape 2 | Convex | 17 | 0 | 28 |
| Example 6 | Shape 2 | Convex | 26 | 0 | 38 |
| Example 7 | Shape 1 | Convex | 20 | 45 | 28 |
| Example 8 | Shape 1 | Convex | 20 | 30 | 28 |
| Example 9 | Shape 3 | Convex | 26 | 0 | 38 |
| Comparative | Circular | Convex | 48 | 0 | 40 |
| Example 1 | shape | | | | |
| Comparative | Shape 1 | Convex | 50 | 50 | 38 |
| Example 2 | | | | | |

TABLE 1-2

| | | Wire | Wire | | |
|---|---|---|---|---|---|
| | Long | width | pitch | Chord arc | |
| | diameter | ratio | ratio | ratio in wire | |
| | L2 | t2/t1 > | p2/p1 > | direction | |
| | [mm] | 0.9 | 0.9 | [%] | Appearance |
| Example 1 | 50 | ∘ | ∘ | 100.2 | A |
| Example 2 | 50 | ∘ | ∘ | 107.1 | B |
| Example 3 | 40 | × | × | 110.9 | C |
| Example 4 | 50 | ∘ | ∘ | 100.6 | A |
| Example 5 | 50 | ∘ | ∘ | 100.4 | A |
| Example 6 | 40 | ∘ | ∘ | 103.2 | B |
| Example 7 | 50 | ∘ | ∘ | 101.3 | B |
| Example 8 | 50 | ∘ | ∘ | 100.8 | A |
| Example 9 | 40 | ∘ | ∘ | 103.2 | B |
| Comparative | 40 | × | × | 112.6 | D |
| Example 1 | | | | | |
| Comparative | 50 | × | × | 114.8 | D |
| Example 2 | | | | | |

As described above, according to the evaluation results of Examples and Comparative examples, as the angle formed between the direction in which an amount of stretching of the wire grid film increases, and the extending direction of the short diameter of the substrate becomes larger, a risk of deterioration of the appearance due to, for example, tilting of the wires becomes higher. The implementation of the present invention can reduce a risk of deterioration of the appearance of the reflective polarizing optical element including a curved substrate due to, for example, tilting of the wires, and in particular, can avoid to some extent deterioration of the appearance at the periphery of the outer circumference in a direction perpendicular to the wires.

### Second Embodiment

The reflective polarizing optical element according to the first embodiment described above can be applied to various devices and apparatus such as an optical device, a display apparatus, and an imaging apparatus. Specifically, the reflective polarizing optical element can be used in optical devices such as a head mounted display, a digital camera, and a video camera. In this embodiment, an optical device and a display apparatus are described as specific application examples of the reflective polarizing optical element according to the first embodiment.

### (Optical Device)

Specific application examples of the reflective polarizing optical element according to the first embodiment include a lens for forming an optical device (photographing optical system) for a camera or a video camera, and a lens for forming an optical device (projecting optical system) for a liquid crystal projector. FIG. 8 is a schematic view for illustrating an example of an exemplary embodiment of an optical device 80 using the reflective polarizing optical element according to the first embodiment. An optical system included in the optical device 80 includes a plurality of lenses arranged in a casing 81, and the reflective polarizing optical element 10 according to the first embodiment can be used for at least one of those lenses.

### (Display Apparatus)

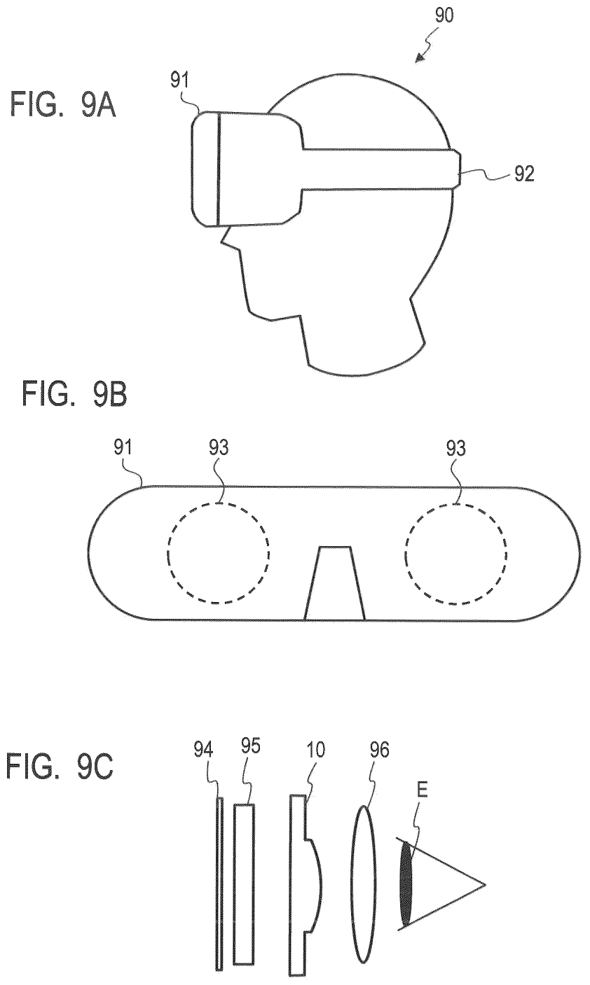

FIG. 9A to FIG. 9C are schematic views for illustrating a configuration of a head mounted display (HMD) 90 which is an example of an exemplary embodiment of a display apparatus using the reflective polarizing optical element 10 according to the first embodiment. FIG. 9A is a side view for illustrating the HMD 90. FIG. 9B is a front view for illustrating the HMD 90. FIG. 9C is a schematic view for illustrating an optical system of the HMD 90.

As illustrated in FIG. 9A and FIG. 9B, the HMD 90 includes a casing 91, a mounting member 92, and display units 93 for a left eye and a right eye, which are arranged in the casing 91. The HMD 90 is mounted on a head of the user by the mounting member 92 so that the display units 93 for the left eye and the right eye are positioned so as to correspond to the left eye and the right eye of the user, respectively.

As illustrated in FIG. 9C, each of the display units 93 includes a display panel 94 and optical elements 10, 95, and 96. For example, the reflective polarizing optical element 10 according to the first embodiment can be used for the optical system. The display panel 94 is a display portion formed of an organic electroluminescence (EL) panel, a liquid crystal panel, or the like, and displays a corresponding video for the left eye or the right eye. The optical elements 10, 95, and 96 image video light emitted from the display panel 94 to the position of an eye E of the user. The optical elements 10, 95, and 96 may include optical-path changing elements depending on the design of the HMD 90. Examples of the optical-path changing elements include transmissive optical elements such as a convex lens and a concave lens, reflective optical elements such as a concave mirror, and phase difference optical elements such as a mirror and a half mirror. The reflective polarizing optical element 10 is installed so as to be positioned between the optical element 95 and the optical element 96 and the eye E. The reflective polarizing optical element 10 forms an optical system together with the optical elements 95 and 96 so as to guide video light that is light emitted from the display panel 94, to the eye of the user, and functions as at least one of optical elements, that is, lenses in the optical system.

Here, a mode using the HMD has been described as the display apparatus to which the reflective polarizing optical element is applied, but the mode of the display apparatus according to this embodiment is not limited to this example. For example, also for a display apparatus in a mode of a projector or the like, the reflective polarizing optical element 10 according to this embodiment can be used similarly to the above-mentioned example.

As described above, a reflective polarizing optical element according to one aspect of the present disclosure includes a substrate and a reflective polarizing film with a wire grid structure, which is exemplified by the wire grid film 12 and the like. For example, the substrate 11 includes the curved surface portion 11a having a surface forming a curved surface. For example, as in the substrate 11-2 or 11-3 exemplified in FIG. 2A or FIG. 2B, in a plan view as viewed in an optical axis direction, the curved surface portion can have a shape surrounded by a plurality of arcs, each of which forms a part of the same circle, and a line connecting ends of adjacent arcs among the plurality of arcs. In such a case, in the present disclosure, the shortest diameter among diameters passing through the center point of this circle in a plan view is defined as a short diameter. Further, for example, as in the substrate 11-4 exemplified in FIG. 2C, in a plan view as viewed in the optical axis direction, the curved surface portion can have a shape formed of an outer shape including a plurality of arcs having different curvatures. In such a case, in the present disclosure, the shortest diameter among diameters passing through a centroid point of this outer shape in a plan view is defined as a short diameter. The reflective polarizing film is adhered to the curved surface portion so that an angle formed between an extending direction of wires in the wire grid and an extending direction of the short diameter of the substrate falls within 45°. When the extending direction of the short diameter of the substrate and the extending direction of the wires are arranged to have such a positional relationship, it is possible to avoid excessive stretching of the base resin film in the wire grid film 12. As a result, it is possible to reduce risks of degradation of polarization transmission characteristics and deterioration of the appearance of the wires.

In order to obtain the effect of the present disclosure, it is more preferred that the angle formed between the extending direction of the wires and the extending direction of the short diameter of the substrate is set to further fall within 30°. When the extending direction of the wires and the extending direction of the short diameter are set to be substantially parallel to each other, partial deterioration of the appearance due to, for example, tilting of the wires can be more effectively reduced.

The wire grid film 12 described above can include the base resin film 201, which is an example forming a base material, and the metal layers (wires) 202 made of conductive metal typified by aluminum. The base material (201) can include the flat sheet 201a and the projecting portions 201b that are formed and arrayed on the sheet 201a at predetermined pitches so as to extend in a specific direction. Further, the wires (202) can be provided so as to be unevenly distributed on one side surfaces of the projecting portions.

The projecting portions 201b can each have a substantially rectangular sectional shape in a sectional view taken along a direction perpendicular to an extending direction of the projecting portions. In this case, it is preferred that the projecting portion 201b have substantially the same height H as the pitch P corresponding to a spacing between two adjacent projecting portions, and that a width of a cross-section of the projecting portion 201b at a first height position, which corresponds to a position of a height 1/H from the surface of the sheet 201a, be approximately ¼ of the pitch P. With regard to the height H, a difference from the surface of the sheet 201a to the highest portion of the projecting portion 201b is defined as the height H. Further, the surface of the sheet 201a in defining the height H can also be defined as, for example, a bottom surface of a recessed portion between two adjacent projecting portions, depending on the shape of the projecting portion. In this embodiment, in consideration of a wavelength of 380 nm, which is the short wavelength of visible light, the pitch P is set to 120 nm, the height H is set to 120 nm, and the width of the projecting portion in a direction parallel to the surface of the sheet at the first height position in a sectional view of the wire grid film is set to 32 nm. In this case, the metal layer 202 can extend from the surface of the sheet 201a to the highest portion of the projecting portion 201b, and at least a portion of the metal layer 202 can be provided above the highest portion of the projecting portion 201b. The pitch P, the height H, and the width of the projecting portion at the first height position are determined in consideration of a wavelength of light to be transmitted and characteristics of the oblique vapor deposition method for forming a metal layer, but may be changed as appropriate according to the wavelength of light to be transmitted, the method for forming a metal layer, and the sectional shape of the projecting portion.

Further, for example, the metal layer 202 to be deposited on the projecting portion 201b can be provided above the top of the projecting portion 201b in a sectional view exemplified in FIG. 3, and can be provided so as to be arranged on only one side surface of one projecting portion 201b. Further, the metal layer 202 can be provided so as to become larger in thickness in a direction parallel to the surface of the sheet 201a in a sectional view, as extending from the top to the bottom of the projecting portion 201b. More specifically, the metal layer 202 can be provided so that a thickness in the direction parallel to the sheet surface at a position of a height 1/10H from the sheet surface is larger than a thickness in the direction parallel to the sheet surface at a position of a height 9/10H from the sheet surface. In addition, the metal layer 202 can be provided so that a thickness in the direction parallel to the sheet surface at the highest portion of the metal layer 202 is smaller than a thickness in the direction parallel to the sheet surface at the highest portion of the projecting portion 201b. When the metal layer 202 is provided on the base resin film 201 in such a form, improvement in adhesiveness of the metal layer 202 to the base resin film 201 is expected. Further, the method for forming a metal layer can be adopted from many options.

Further, it can also be analogized that the reflective polarizing optical element according to one aspect of the present disclosure reduces deterioration of the appearance by satisfying, among the evaluation items described in Examples, items except for the item relating to visual observation on tilting of the wires or the like. Specifically, when a reflective polarizing optical element satisfies desired conditions for the chord arc ratio, the wire width ratio, the wire pitch ratio, and the like, such a reflective polarizing optical element can be recognized as the reflective polarizing optical element according to the present disclosure.

For example, with regard to the chord arc ratio, it is only required that, in a sectional view taken along a direction perpendicular to the extending direction of the projecting portion 201b, a curved surface shape in the extending direction of the wires (202) in the wire grid film 12 have a chord arc ratio larger than 100% and smaller than 110%. In this case, the chord arc ratio (%) can be calculated from a numerical formula in which the shortest distance between two specific end points on a curved surface shape of the curved substrate is divided by a distance connecting the two specific points by a straight line, and then is multiplied by 100. The two specific points can be defined, for example, as points on the curved surface shape, which correspond to both end portions in the direction parallel to the extending direction of the wires, and at which the chord arc ratio is the maximum in the formula described above.

Further, with regard to the wire width, it is only required that, when t1 and t2 respectively represent the maximum wire width and the minimum wire width after the wire grid film 12 is adhered to the substrate 11, the width ratio t2/t1>0.9 be satisfied. The wire width ratio can be obtained from, for example, a ratio of the width of the metal layer at the center portion of the element to the width of the metal layer at the end portion of the element. More specifically, the wire width t1 can be defined as the maximum wire width in a curve in an extending direction of the wire located on the curved surface specified in the calculation of the chord arc ratio. Further, in this case, the wire width t2 corresponding to the wire width t1 can be defined as a wire width at a position of any one of two specific points on end portions of the curve surface of the wire that is located on the curved surface specified in the calculation of the chord arc ratio. Here, the wire widths t1 and t2 are defined as described above, but a method for determining the wire widths is not limited to the example described above. For example, a wire width can also be measured in the arraying direction of the wires, and conditions can be determined by obtaining the wire width at each position on the entire curved surface.

Further, with regard to the wire pitch, it is only required that, when p1 and p2 respectively represent the maximum wire pitch and the minimum wire pitch after the wire grid film 12 is adhered to the substrate 11, p2/p1>0.9 be satisfied. The wire pitch ratio can be obtained from, for example, a ratio of the spacing between metal layers at the center portion of the element to the spacing between metal layers at the end portion of the element. More specifically, the wire pitch p1 can be defined as the maximum wire pitch between a wire located on the curve in the extending direction of the wire, which is located on the curved surface specified in the calculation of the chord arc ratio, and an adjacent wire. Further, in this case, corresponding to the wire pitch p1, the wire pitch p2 can be defined as the wire pitch between the wire, which is located on the curved surface specified in the calculation of the chord arc ratio, and the adjacent wire, at a position of any one of the two specific points. Here, the wire pitches p1 and p2 are defined as described above, but a method for determining the wire pitches is not limited to the example described above. For example, a wire pitch can also be measured in the arraying direction of the wires, and conditions can be determined by obtaining the wire pitch at each position on the entire curved surface.

Further, in the present disclosure, for example, as exemplified in FIG. 1A and FIG. 1B, the substrate 11 can include the peripheral edge portion 11b provided at a peripheral edge of the curved surface portion 11a. Such a peripheral edge portion 11b is formed, thereby obtaining the effect, such as improvement in degree of freedom when the reflective polarizing optical element is fixed to the optical device. Further, as exemplified in FIG. 5A to FIG. 5C, the wire grid film can be adhered to the curved surface portion through intermediation of the adhesive layer 55. This can reduce restrictions in material, which may arise with respect to heating of the reflective polarizing film.

Further, the present disclosure can form an optical device (80, 90) including a casing (81, 91) and an optical system that is arranged in the casing and includes at least one optical element including, for example, the reflective polarizing optical element 10 described above. In addition, the present disclosure can form a display apparatus including a casing 91, an optical system (10, 95, 96) that is arranged in the casing and includes at least one optical element, and a display portion (94) that emits light to be guided by the optical system.

Further, the method for manufacturing a reflective polarizing optical element according to one aspect of the present disclosure includes a step of adhering a wire grid film for a polarization beam splitter having a wire grid structure to a substrate including a curved surface portion having a surface forming a curved surface. In this case, when the curved surface portion has the shape exemplified in FIG. 2A or FIG. 2B in a plan view as viewed in the optical axis direction, the shortest diameter among diameters passing through the center point of the single circle forming a plurality of arcs in a plan view can be defined as a short diameter. Further, when the curved surface portion has the shape exemplified in FIG. 2C, the shortest diameter among diameters passing through the centroid point of the outer shape including a plurality of arcs having different curvatures in a plan view can be defined as a short diameter. The wire grid film is adhered to the curved surface portion so that an angle formed between an extending direction of the wires and an extending direction of the short diameter of the substrate falls within 45°. In addition, when the curved surface portion is convex, for example, the extending direction of the short diameter can also be defined as an extending direction of a straight line in a plan view, which connects a point on the curved surface with which the wire grid film is first brought into contact at the time of adhering, and a point on the circumference of the curved surface that the wire grid film first reaches to each other. Further, when the curved surface portion is concave, the extending direction of the short diameter can also be defined as a direction that is the shortest distance connecting between a point on the circumference of the curved surface with which the reflective polarizing film is first brought into contact at the time of adhering, and a point on the curved surface, such as the centroid point of the curved surface portion, at which adhering is to be finished.

When the reflective polarizing film is adhered to the curved surface portion, the angle formed between the extending direction of the wires and the extending direction of the short diameter of the substrate is set to fall within 30°, the effect of the present disclosure is more suitably obtained. The reflective polarizing film can be adhered to the curved surface portion by pressing the reflective polarizing film onto the substrate. Further, the reflective polarizing film in a heated state can also be adhered to the curved surface portion.

As described above, according to the present disclosure, with the suppression of the increase in stretching in the extending direction of the wires, which occurs when the wire grid film is adhered to the substrate, tilting of the wires is reduced so that scattering of incident light can be reduced. Thus, according to one aspect of the present disclosure, a risk of deterioration of the appearance of the reflective polarizing optical element can be reduced at the time when the wire grid film is adhered to the curved substrate.

The present disclosure is described above with reference to the embodiments and Examples. However, the present disclosure is not limited to the above-mentioned embodiments and Examples. The present disclosure also encompasses the disclosure modified within a scope not deviated from the gist of the present disclosure, and the disclosure equivalent to the present disclosure. Further, Examples described above may be combined with each other as appropriate within the scope not deviated from the gist of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-134894, filed Aug. 13, 2024, which is hereby incorporated by reference herein in its entirety.

What is claimed is:

1. A reflective polarizing optical element comprising:
a substrate including a curved surface portion having a surface forming a curved surface, the curved surface portion having, in a plan view as viewed in an optical axis direction, when the curved surface portion has a shape surrounded by a plurality of arcs, each of which forms a part of the same circle in the plan view, and by a line connecting ends of adjacent arcs among the plurality of arcs, a short diameter that is defined by the shortest diameter among diameters passing through a center point of the circle in the plan view, the curved surface portion having, when the curved surface portion has a shape formed of an outer shape including a plurality of arcs having different curvatures, a short diameter that is defined by the shortest diameter among diameters passing through a centroid point of the outer shape in the plan view; and
a wire grid film for a polarization beam splitter having a wire grid structure, the wire grid film being configured to be adhered to the curved surface portion so that an angle formed between an extending direction of wires in the wire grid film and an extending direction of the short diameter of the substrate falls within 45°.

2. The reflective polarizing optical element according to claim 1, wherein the angle formed between the extending direction of the wires and the extending direction of the short diameter of the substrate falls within 30°.

3. The reflective polarizing optical element according to claim 1,
wherein the wire grid film includes:
a base material including a flat sheet and projecting portions formed and arrayed on the sheet at predetermined pitches so as to extend in a specific direction; and
a metal layer that is made of conductive metal and provided so as to be unevenly distributed on one side surface of each of the projecting portions,
wherein, in a sectional view taken along a direction perpendicular to an extending direction of the projecting portions, each of the projecting portions has a substantially rectangular sectional shape, a pitch P, which is a spacing between the two adjacent projecting portions, is 120 nm, and a height H, which is a difference in height from a highest portion of the projecting portion to a sheet surface, is 120 nm,
wherein, when a position of H/2 from the sheet surface is defined as a first height position, a width of the projecting portion in a direction parallel to the sheet surface at the first height position in the sectional view is 32 nm, and
wherein the metal layer extends from the sheet surface to the highest portion of the projecting portion, and at least a portion of the metal layer is provided above the highest portion of the projecting portion.

4. The reflective polarizing optical element according to claim 3,
wherein, in the sectional view, a thickness of the metal layer in a direction parallel to the sheet surface at a position of 1/10H of the height H from the sheet surface is larger than a thickness of the metal layer in the direction parallel to the sheet surface at a position of 9/10H of the height H from the sheet surface, and
wherein a thickness of the metal layer in the direction parallel to the sheet surface at a highest portion of the metal layer is smaller than a thickness of the metal layer in the direction parallel to the sheet surface at the highest portion of the projecting portion.

5. The reflective polarizing optical element according to claim 3, wherein, in the sectional view taken along the direction perpendicular to the extending direction of the projecting portions, a curved surface shape in the extending direction of the wires in the wire grid film has a chord arc ratio larger than 100% and smaller than 110%, which is calculated as follows:
Chord arc ratio (%)=(shortest distance between two specific end points on a curved surface of a curved surface portion on the curved surface)/(distance connecting the two specific points by a straight line)×100.

6. The reflective polarizing optical element according to claim 5, wherein t2/t1>0.9 is satisfied,
where t1 and t2 respectively represent a maximum wire width and a minimum wire width obtained after the wire grid film is adhered to the substrate.

7. The reflective polarizing optical element according to claim 6, wherein the maximum wire width t1 is a maximum wire width in a curve in an extending direction of a wire located on the curved surface specified in calculation of the chord arc ratio, and the minimum wire width t2 is a wire width at a position of any one of the two specific points on end portions of the curved surface of the wire located on the curved surface specified in the calculation of the chord arc ratio.

8. The reflective polarizing optical element according to claim 5, wherein p2/p1>0.9 is satisfied,
where p1 and p2 respectively represent a maximum wire pitch and a minimum wire pitch obtained after the wire grid film is adhered to the substrate.

9. The reflective polarizing optical element according to claim 8, wherein the maximum wire pitch p1 is a maximum wire pitch between a wire located on a curve in an extending direction of a wire, which is located on the curved surface specified in the calculation of the chord arc ratio, and an adjacent wire, and the minimum wire pitch p2 is a wire pitch between the wire, which is located on the curved surface specified in the calculation of the chord arc ratio, and the adjacent wire, at a position of any one of the two specific points.

10. The reflective polarizing optical element according to claim 1, wherein the substrate includes a peripheral edge portion provided at a peripheral edge of the curved surface portion.

11. The reflective polarizing optical element according to claim 1, wherein the wire grid film is adhered to the curved surface portion through intermediation of an adhesive layer.

12. An optical device comprising:
a casing; and
an optical system including at least one optical element arranged in the casing,
wherein the at least one optical element includes the reflective polarizing optical element of claim 1.

13. A display apparatus comprising:
a casing;
an optical system including at least one optical element arranged in the casing; and
a display portion configured to emit light to be guided by the optical system,
wherein the at least one optical element includes the reflective polarizing optical element of claim 1.

14. A method for manufacturing a reflective polarizing optical element comprising:
defining, in a substrate including a curved surface portion having a surface forming a curved surface, in a plan view as viewed in an optical axis direction, when the curved surface portion has a shape surrounded by a plurality of arcs, each of which forms a part of the same circle in the plan view, and by a line connecting ends of adjacent arcs among the plurality of arcs, a short diameter of the curved surface portion that is defined by the shortest diameter among diameters passing through a center point of the circle in the plan view, or defining, when the curved surface portion has a shape formed of an outer shape including a plurality of arcs having different curvatures, a short diameter of the curved surface portion that is defined by the shortest diameter among diameters passing through a centroid point of the outer shape in the plan view; and
adhering a wire grid film for a polarization beam splitter having a wire grid structure to the curved surface portion so that an angle formed between an extending direction of wires in the wire grid film and an extending direction of the short diameter of the substrate falls within 45°.

15. The method for manufacturing a reflective polarizing optical element according to claim 14, wherein, when the wire grid film is adhered to the curved surface portion, the substrate is arranged so that a tangent line at a center point of the short diameter of the curved surface portion is parallel to the wire grid film.

16. The method for manufacturing a reflective polarizing optical element according to claim 14, wherein, when the wire grid film is adhered to the curved surface portion, the angle formed between the extending direction of the wires and the extending direction of the short diameter of the substrate falls within 30°.

17. The method for manufacturing a reflective polarizing optical element according to claim 14, further comprising adhering the wire grid film to the curved surface portion by pressing the wire grid film onto the substrate.

18. The method for manufacturing a reflective polarizing optical element according to claim 14, wherein the wire grid film in a heated state is adhered to the curved surface portion.

19. A method for manufacturing a reflective polarizing optical element comprising adhering a wire grid film for a polarization beam splitter having a wire grid structure to a substrate including a curved surface portion having a surface forming a curved surface,
wherein in a plan view when the substrate is viewed in an optical axis direction, an angle formed between an extending direction of a straight line that connects a point on the curved surface with which the wire grid film is first brought into contact at the time of the adhering, and a point on a circumference of the curved surface that the wire grid film first reaches to each other, and an extending direction of wires in the wire grid structure is 45°.
